(19) United States
(12) Patent Application Publication
(10) Pub. No.: US 2004/0239118 A1
(43) Pub. Date: Dec. 2, 2004

(54) Intertia constant generator

(76) Inventor: Jung-Ching Peng, Taipei (TW)

Correspondence Address: Jung-Ching PENG, PO Box 82-144, Taipei, TW

(21) Appl. No.: 10/446,796

(22) Filed: May 29, 2003

(51) Int. Cl. H02P 9/04

(52) U.S. Cl. 290/1 R

(57) ABSTRACT

An inertia constant generator that needs only the external power to drive the motor upon start-up, and then achieves constant operation with residual power output by supplying partial power output to keep driving the motor, essentially comprised of a drive motor, multiple turning gears, a spindle, two belt turning gear, a belt, multiple ratio gear fixtures, multiple turning gear fixtures, and a power generation unit working on the principle of tuning gear inertia.

### BACKGROUND OF THE INVENTION

(a) Field of the Invention

The present invention is related to an inertia constant generator, and more particularly, to one that uses multiple turning gears to achieve the maximal inertia to drive the generator delivering output for constant operation.

(b) Description of the Prior Art

A conventional power generator includes an armature having wire conductor coiled around an iron core and rotatably mounted between two poles of a magnet, with a pair of brushes which rotatably rub a pair of slip rings connected to two ends of the armature for collecting alternating current as produced from the generator; or with a pair of brushes which rotatably contact a commutator consisting of two insulated segments for collecting direct current from the generator. However, the conventional power generator causes pollution and consumes a lot of natural resources.

### SUMMARY OF THE INVENTION

The primary purpose of the present invention is to provide an inertia constant generator that needs only the external power to drive the motor upon start-up, and then achieves constant operation with residual power output by supplying partial power output to keep driving the motor. To achieve the purpose, the present invention is comprised of a drive motor, multiple turning gears, a spindle, two belt turning gear, a belt, multiple ratio gear fixtures, multiple turning gear fixtures, and a power generation unit. The principle of turning gear inertia is applied. According to the principle, the greater circumference of a circle is, the less effort is required when a mobile bearing is provided at the center to drive it from the outer diameter. For example, a metric ton of iron is made into a ball and a mobile bearing is provided at it center. An external force is applied to its outer diameter to turn it around. Since the short torque demands greater force to be applied, and the resulted kinetic is smaller due to small inertia is availed. However, when the same weight of iron is used and made into a turning gear in a diameter of ten meters, much less effort is required to turn it around from its outer diameter due to longer torque; and greater kinetic is available since the inertia is greater. Multiple turning gears in different sizes are used in the present invention. Once the largest one rotates as driven by a motor, the least kinetic is applied to avail the maximal inertia, and thus the maximal kinetic, which in turn is applied to drive the next largest turning gear by means of a ratio gear to achieve the maximal inertia and highest rpm. Similarly, the rpm required for the generator is arrived at together with the sum of the inertia of all the turning gears. The last turning gear is incorporated to the power generator to achieve the purpose of power output. In this method, small portion of the output can be supplied to drive the motor. Once each turning gear achieves its maximal rpm for obtaining the maximal inertia, torsion and kinetic for the generator to output the power. The sum of the kinetic resulted from the sum of inertia of the entire turning gears is always greater than the power needed to drive the motor. Therefore, it takes only an external power to start the generator of the present invention. Once the generator is started, certain portion of the output is supplied to drive the motor while the remaining output can be used for other purposes with the constant power generation.

The foregoing object and summary provide only a brief introduction to the present invention. To filly appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIGS. and 1B are exploded views of a preferred embodiment of the present invention.

FIG. 2 is a sectional view of the preferred embodiment of the present invention.

FIG. 3 is a schematic view showing the preferred embodiment of the present invention as assembled.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

An inertia constant generator of the present invention is comprised of a drive motor, multiple turning gears, a spindle, two belt turning gears, belt, multiple ratio gear fixtures, multiple turning gear fixtures, and a power generation unit.

Referring to FIGS. 1A and 1B for a preferred embodiment of the present invention. Wherein, one end of a spindle (03) is inserted into a hole of a fixture (02) and a belt gear (16) is inserted into the right end of the spindle (03). Multiple turning gears (15), (14), (13), (12), (11) and (10) are inserted into the spindle (03) in position and in sequence from the left end of the spindle (03) to rotate.

As illustrated in FIG. 1B, a motor (31) is fixed below the tuning gear (10). A transmission shaft gear (33) is engaged to the outer teeth of the turning gear (10); a pinion gear (21) on the ratio gear (21), to those teeth on the outer diameter of the turning gear (10); the gear above the ratio gear (21), to those teeth of the outer diameter of the turning gear (11); a pinion on the ratio gear (22), to those teeth on the outer diameter of the turning gear (11); the gear above the ratio gear (22), to those teeth of the outer diameter of the turning gear (12); a pinion on the ratio gear (23), to those teeth on the outer diameter of the turning gear (12); the gear above the ratio gear (23), to those teeth of the outer diameter of the tuning gear (13); a pinion on the ratio gear (24), to those teeth on the outer diameter of the turning gear (13); the gear above the ratio gear (23), to those teeth of the outer diameter of the turning gear (14); a pinion on the ratio gear (25), to those teeth on the outer diameter of the turning gear (14); and the gear above the ratio gear (25), to those teeth of the outer diameter of the turning gear (15). The turning gear (15) is integrated with the belt gear (16), and the belt gear (16) is connected with a belt (17) to the belt turning gear (34) on the transmission shaft of the generator (32).

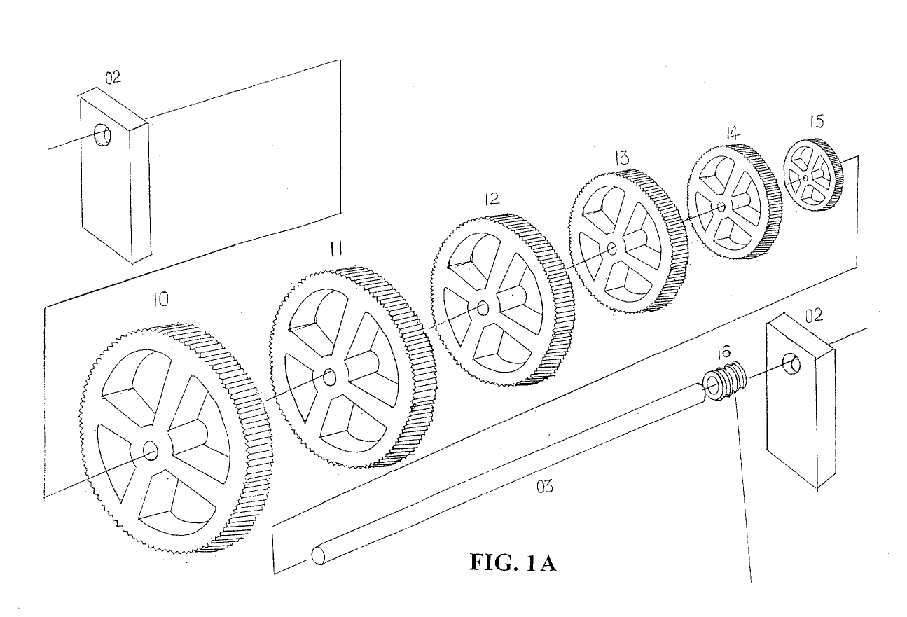

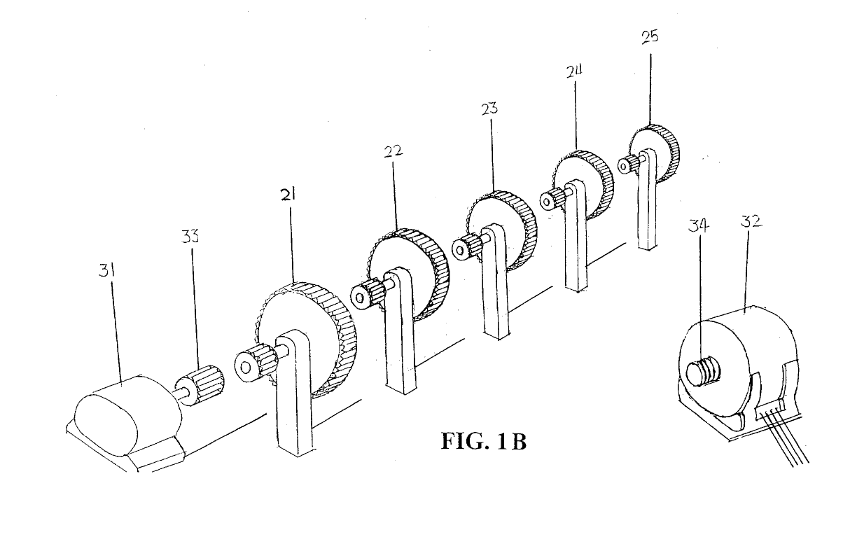

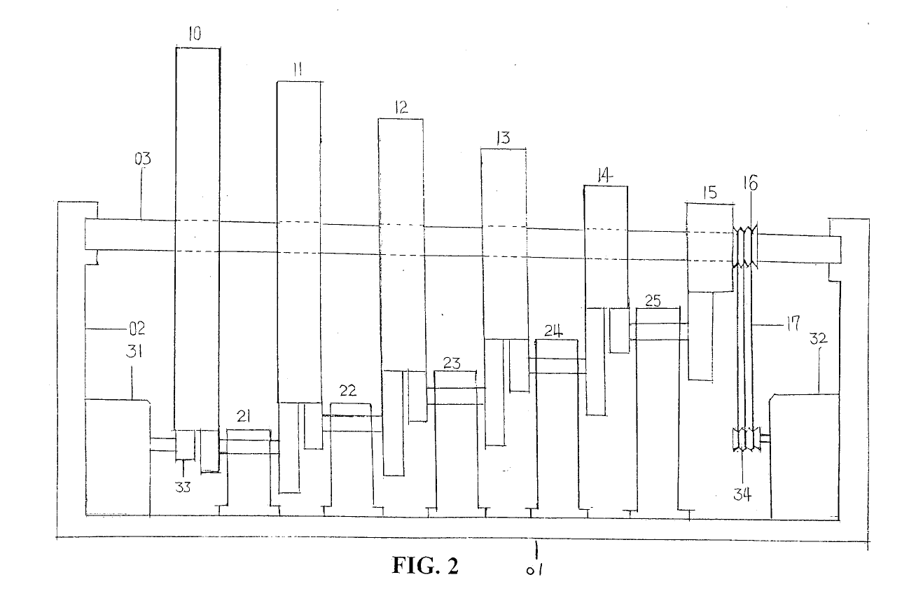

As illustrated in FIG. 2 for a sectional view of the design of the structure of the preferred embodiment of the present invention, a turning gear fixture (02) is fixed to the fixation base (01) and the spindle (03) of fixed to the turning gear fixture (02). Those multiple turning gears (10), (11), (12), (13), (14), (15) and the belt turning gear (16) are inserted in position into the spindle (03) in sequence from left to right, and turning concentrically with the spindle (03) as the center. A drive motor (31) is fixed at the left lower corner of the fixation base (01) with the transmission shaft gear (33) engaged to the outer diameter on the left half of the turning gear (10), the pinion to the left of the ratio gear (21) engaged to those teeth of the outer diameter on the right half of the turning gear (10), and the gear to the right of the ratio gear (21) to those teeth of the outer diameter on the left half of the turning gear (11); the pinion to the left of the ratio gear (22) engaged to those teeth of the outer diameter on the right half of the turning gear (11), and the gear to the right of the ratio gear (22) to those teeth of the outer diameter on the left half of the turning gear (12); the pinion to the left of the ratio gear (23) engaged to those teeth of the outer diameter on the right half of the turning gear (12), and the gear to the right of the ratio gear (23) to those teeth of the outer diameter on the left half of the turning gear (13); the pinion to the left of the ratio gear (24) engaged to those teeth of the outer diameter on the right half of the turning gear (13), and the gear to the right of the ratio gear (24) to those teeth of the outer diameter on the left half of the turning gear (14); and the pinion to the left of the ratio gear (25) engaged to those teeth of the outer diameter on the right half of the turning gear (14), and the gear to the night of the ratio gear (25) to those teeth of the outer diameter on the left half of the turning gear (15). The turning gear (15) is integrated with the belt turning gear (16), and is connected to the belt tuning gear (34) on the transmission shaft of the generator (32) with the belt (17).

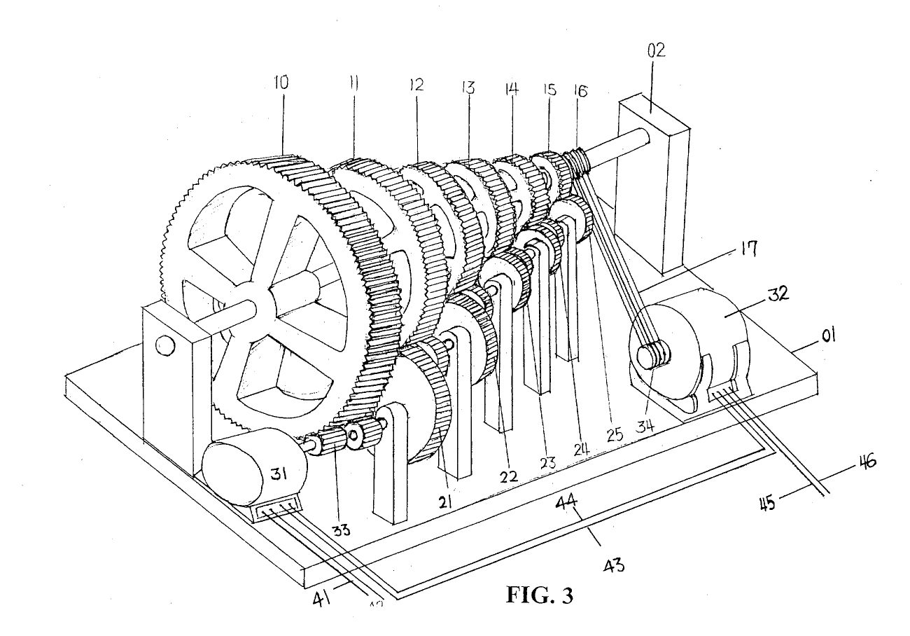

Now referring to FIG. 3 for an example of the structural design of the inertia constant generator, the drive motor (31) is turning when two power input wires (41), (42) are active to drive the outer diameter of the turning gear (10), and the turning gear (10) in turn drives respectively those turning gears (10), (11), (12), (13), (14), (15) through those ratio gears (21), (22), (23), (24), (25) to provide the maximal sum of inertia from outer diameters of those tuning gears (10), (11), (12), (13), (14), (15), thus the maximal torsion and kinetic. According to the working principle of the ratio gear, the maximal rpm is provided to the belt turning gear (16) to drive the belt turning gear (34) on the transmission shaft of the generator (32) to deliver power into the drive motor (31) through two power output wires (44), (43). Once the rpm of the drive motor (31) becomes normal, the external power applied from those two power feed wires (41) (42) is interrupted by a circuit breaker while the residual power is outputted from the generator (32) through another two power output wires (45) (46) to achieve the purpose of inertia constant power generation.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An inertia constant generator comprising a drive motor, multiple turning gears, a spindle, two belt turning gears, a belt, multiple gear fixtures, multiple turning gear fixtures, and a power generation unit; the spindle being inserted through those multiple turning gears in sequence depending on their sizes with the largest one closest to the drive motor; an external power being applied to the largest turning gear; the remaining turning gears being driven in sequence with respective ratio gears and pinions; the smallest turning gear being integrated with the belt turning gear and connected to another belt turning gear provided on a transmission shaft of the generation unit with the belt; sum of maximal dynamic from the maximal torsion is availed from the maximal inertia delivered from those multiple turning gears with the rpm required by the generator to be supplied by those ratio gears; and constant power generation being achieved by the drive motor fed by the generator while outputting the residual power.
